(19) United States
(12) Patent Application Publication
(10) Pub. No.: US 2025/0319907 A1
(43) Pub. Date: Oct. 16, 2025

(54) Autonomous Driving Apparatus and Control Method Therefor

(71) Applicants: Hyundai Motor Company, Seoul (KR); Kia Corporation, Seoul (KR)

(72) Inventors: Moon Hyung Song, Cheonan-Si (KR); Young Bin Min, Hwaseong-Si (KR); Dae Hoon Park, Hwaseong-Si (KR)

(21) Appl. No.: 19/175,132

(22) Filed: Apr. 10, 2025

(30) Foreign Application Priority Data
Apr. 11, 2024 (KR) 10-2024-0048941
Mar. 26, 2025 (KR) 10-2025-0038618

(51) Int. Cl. B60W 60/00; B60W 50/08; B60W 50/14

(52) U.S. Cl. CPC B60W 60/0057; B60W 50/082; B60W 60/0015; B60W 50/14; B60W 2050/146; B60W 2420/403; B60W 2520/10; B60W 2540/10; B60W 2540/12; B60W 2540/18; B60W 2540/215; B60W 2552/05; B60W 2552/30; B60W 2554/40; B60W 2555/20; B60W 2556/45

(57) ABSTRACT

An apparatus of a vehicle may include: an input interface, a processor, and a memory storing at least one instruction. The at least one instruction may be configured, when executed by the processor communicating with the memory, to cause the apparatus to: change, based on the input interface receiving a user request within a threshold time duration and based on a manual mode change requirement being satisfied, an autonomous driving mode of the vehicle from a first mode to a second mode; change, based on the input interface receiving no user request within the threshold time duration, and based on the manual mode change requirement and an automatic mode change requirement being satisfied, the autonomous driving mode from the first mode to the second mode; and control the vehicle to perform an autonomous driving operation of the second mode.

### CROSS-REFERENCE TO RELATED APPLICATION

The present application claims the benefit of Korean Patent Application No. 10-2024-0048941, filed on Apr. 11, 2024 in the Korean Intellectual Property Office, and Korean Patent Application No. 10-2025-0038618, filed on Mar. 26, 2025 in the Korean Intellectual Property Office, the entire disclosures of which are incorporated herein by reference for all purposes.

### TECHNICAL FIELD

The present disclosure relates to an autonomous driving apparatus and a control method thereof.

### BACKGROUND

The content described hereinbelow merely provides background information on the present disclosure and does not constitute prior art.

Advanced Driver Assistance System (ADAS) are being developed to assist drivers in driving vehicles. The ADAS is also referred to as autonomous driving or as an Autonomous Driving System (ADS).

Unlike autonomous driving on regular roads such as city streets, highway (e.g., freeway) autonomous driving may have unique characteristics and challenges. This is because highways typically do not have intersections, traffic lights, or pedestrians, and are relatively constant in terms of the flow of traffic, making road conditions relatively more predictable than on non-highway roads.

Highways may be a suitable environment for utilizing various autonomous driving technologies, such as a Lane Keeping Assist System (LKAS) that controls a vehicle to stay in its lane, an Adaptive Cruise Control (ACC) that automatically adjusts a speed of the vehicle while maintaining a distance (e.g., a constant or substantially constant distance) from the vehicle in front, and an Automatic Lane Change System (ALCS) that automatically changes lanes, for example, with little or no driver intervention, based on real-time road conditions.

Depending on a type of an autonomous driving mode, the scope and type of driving tasks that a driver is required to perform may vary. For example, when switching the autonomous driving mode from level 3 to level 2, the number of driving tasks that the driver is expected to perform may increase.

The autonomous driving mode may be changed manually based on the driver's judgement or automatically based on the judgement of the autonomous driving system.

When the driver is unable to perform driving tasks, it may not be desirable to increase the driver's driving tasks by manually or automatically changing the autonomous driving mode. Therefore, a method of changing the autonomous driving mode that ensures the driver's safety is required.

### SUMMARY

In view of the above, the present disclosure provides a method and apparatus that can safely change an autonomous driving mode.

The objectives to be achieved by the present disclosure are not limited to the above-mentioned objectives, and other objectives which are not mentioned will be clearly understood by those skilled in the art from the following description.

According to one or more example embodiments of the present disclosure, an apparatus of a vehicle may include: an input interface configured to receive, from a user, a user request to change an autonomous driving mode of the vehicle; a processor; and a memory storing at least one instruction. The at least one instruction may be configured, when executed by the processor communicating with the memory, to cause the apparatus to: change, based on the input interface receiving the user request within a threshold time duration and based on a manual mode change requirement being satisfied, the autonomous driving mode from a first mode to a second mode; change, based on the input interface receiving no user request within the threshold time duration, based on the manual mode change requirement being satisfied during the threshold time duration, and based on an automatic mode change requirement being satisfied, the autonomous driving mode from the first mode to the second mode; and control the vehicle to perform an autonomous driving operation of the second mode.

The first mode may include an autonomous driving level 1, wherein the second mode comprises an autonomous driving level 2. The manual mode change requirement may include at least one of: a road on which the vehicle is driving being a predetermined type of road, activation of a longitudinal control mode of the vehicle and a lateral control mode of the vehicle, or a maximum operating speed that is set for the longitudinal control mode being less than a posted speed limit.

The first mode may include an autonomous driving level 2. The second mode may include an autonomous driving level 3. The manual mode change requirement may include at least one of: activation of a longitudinal control mode of the vehicle and a lateral control mode of the vehicle, or a first sensor detecting a surrounding environment of the vehicle and a second sensor detecting a status of the vehicle are in a normal state, wherein the first sensor and the second sensor satisfy requirements associated with the autonomous driving level 3.

The at least one instruction may be configured, when executed by the processor, to further cause the apparatus to change, based on detecting a predetermined vehicle operation performed by the user, the autonomous driving mode to a standby mode.

The predetermined vehicle operation may include at least one of acceleration, braking, or steering.

The at least one instruction may be configured, when executed by the processor, to further cause the apparatus to set, based on determining to change the autonomous driving mode, a mode switching time during which the changing of the autonomous driving mode is to be completed.

The mode switching time may be based on user image data generated by photographing the user.

The first mode may include an autonomous driving level 2. The second mode may include an autonomous driving level 3. The automatic mode change requirement may include: at least a section of a path to a final destination being suitable for the autonomous driving level 3, a length of the section of the path being greater than or equal to a threshold distance, the section of the path being an operation design domain (ODD), and the vehicle not being in a minimum risk maneuver (MRM) situation.

The at least one instruction may be configured, when executed by the processor, to further cause the apparatus to determine whether the section of the path is the ODD based on pre-stored map data.

The at least one instruction may be configured, when executed by the processor, to further cause the apparatus to determine whether the section of the path is the ODD based on traffic condition data obtained by communicating with an external device.

The at least one instruction may be configured, when executed by the processor, to further cause the apparatus to determine whether the section of the path is the ODD based on environment data generated by detecting a surrounding environment of the vehicle.

The at least one instruction is configured, when executed by the processor, to further cause the apparatus to determine whether the section of the path is the ODD based on at least one of: curvature data, weather data, or traffic data, for the path.

The first mode may be an autonomous driving level 3 with a lane change function deactivated. The second mode may include an autonomous driving level 3 with the lane change function activated. The automatic mode change requirement may include at least one of: at least a section of a path to a final destination being suitable for the second mode, a length of the section of the path being greater than or equal to a threshold distance, the section of the path being an operation design domain (ODD), and the vehicle not being in a minimum risk maneuver (MRM) situation.

The second mode may be an autonomous driving level 3. The at least one instruction may be configured, when executed by the processor, to further cause the apparatus to: display, via a display device of the vehicle, at least one of: a path to a final destination, or a section of the path to be driven in the second mode.

According to one or more example embodiments of the present disclosure, a method performed by an apparatus of a vehicle may include: changing, based on an input interface of the vehicle receiving no user request within a threshold time duration to change an autonomous driving mode of the vehicle, based on a manual mode change requirement being satisfied during the threshold time duration, and based on an automatic mode change requirement being satisfied, the autonomous driving mode from a first mode to a second mode; and controlling the vehicle to perform an autonomous driving operation of the second mode.

The method may further include: changing, based on detecting a predetermined vehicle operation performed by a user, the autonomous driving mode to a standby mode.

According to one or more example embodiments of the present disclosure, an apparatus of a vehicle may include: a user interface; a processor; and a memory storing at least one instruction that is configured, when executed by the processor communicating with the memory, to cause the apparatus to: control the vehicle to operate in a first autonomous driving mode; based on determining that the user interface received, for at least a threshold time duration, no user request for a second autonomous driving mode, based on determining a cruise control speed of the vehicle being below a posted speed limit, and based on a road on which the vehicle is driving being suitable for the second autonomous driving mode, control the vehicle to operate in the second autonomous driving mode.

The at least one instruction may be configured, when executed by the processor, to cause the apparatus to control the vehicle to operate in the second autonomous driving mode further based on at least one of: the road being a highway, or a longitudinal control mode of the vehicle being activated.

The first autonomous driving mode may be an American Society of Automotive Engineers (SAE) autonomous driving level 1. The second autonomous driving mode may be an SAE autonomous driving level 2.

The at least one instruction may be configured, when executed by the processor, to cause the apparatus to control the vehicle to operate in the second autonomous driving mode by: controlling the vehicle to operate in the second autonomous driving mode in a section of a path to a destination of the vehicle; and indicating, via the user interface, that the second autonomous driving mode is activated for the section.

According to one or more example embodiments of the present disclosure, an autonomous driving mode may be changed more safely.

### BRIEF DESCRIPTION OF THE DRAWINGS

FIG. 1 is a functional block diagram illustrating an autonomous driving apparatus.

FIG. 2 is a diagram illustrating a change in autonomous driving mode.

FIG. 3 is a flowchart illustrating a method of controlling an autonomous driving apparatus.

FIG. 4 is a flowchart that initiates processes S360, S370, S380, and S390 of FIG. 3, and illustrates a process when automatically changing from an autonomous driving mode at level 2 to an autonomous driving mode at level 3.

FIG. 5 is a flowchart illustrating a process of changing to a standby mode.

FIGS. 6A, 6B, 6C and 6D illustrate a driving method on a highway.

FIG. 6A is a diagram illustrating a driving method when highway entrance and exit ramps are included in an entire path.

FIG. 6B is a diagram illustrating a driving method when a road construction section is present in the entire path.

FIG. 6C is a diagram illustrating a driving method when there is a section in the entire path where no map data is present.

FIG. 6D is a diagram illustrating a case where a vehicle is manually driven on the entire section along the entire path.

FIG. 7 is a block diagram schematically illustrating an exemplary vehicle system that may be used to implement the method or apparatus described in the present disclosure.

### DETAILED DESCRIPTION

Hereinafter, one or more example embodiments of the present disclosure will be described in detail with reference to exemplary drawings. Note that when components in each drawing are denoted by reference numerals, the same components are denoted by the same numerals as much as possible even if they are denoted on different drawings. In addition, in describing the present disclosure, if it is determined that a specific description of a related known configuration or function may obscure the gist of the present disclosure, the detailed description thereof will be omitted.

In describing the components of the present disclosure, the terms “first”, “second”, “A”, “B”, “(a)”, “(b)”, and the like may be used. These terms are only used to distinguish the components from other components, and the nature, sequence, order, or the like of the components is not limited by these terms.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

When any component is described as being “connected,” “coupled,” or “linked” to another component, it should be understood that the component may be directly connected or linked to the other element, but another component may also be “connected,” “coupled,” or “linked” between each component.

Throughout the specification, when it is stated that a certain portion “includes” or “comprises” a specific component, it shall be understood that, unless explicitly otherwise specified, this does not exclude other components but may further include additional components.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Unless otherwise specified, it should be understood that the description of one example embodiment may be applied to other embodiments.

The description set forth below in connection with the appended drawings is intended to describe example embodiments of the present disclosure and is not intended to represent the only embodiments in which the present disclosure may be practiced.

Terms used in the present disclosure may be defined as follows.

A vehicle may be equipped with an Automated Driving System (ADS), which may enable autonomous driving. For example, the vehicle can perform at least one of the following actions: steering, accelerating, decelerating, changing lanes, braking, and stopping without driver intervention by the ADS. Examples of the ADS may include at least one among PDCMS (Pedestrian Detection and Collision Mitigation System), LCDAS (Lane Change Decision Aid System), LDWS (Land Departure Warning System), ACC (Adaptive Cruise Control), LKAS (Lane Keeping Assistance System), RBDPS (Road Boundary Departure Prevention System), CSWS (Curve Speed Warning System), FVCWS (Forward Vehicle Collision Warning System), and LSF (Low Speed Following).

A user (or a “driver”) may be a human who uses a vehicle and receives services from an autonomous driving system.

The vehicle that an autonomous driving system is actively controlling may be referred to as an ego vehicle, a host vehicle, or an autonomous vehicle. The ego vehicle (e.g., the host vehicle, the autonomous vehicle, etc.) may be the vehicle that is equipped with the autonomous driving system. A car that is ahead of the ego vehicle (e.g., in the same driving lane as the ego vehicle) may be referred to as a vehicle in front, a lead vehicle, a leading vehicle, or a preceding vehicle. A car that follows the ego vehicle (e.g., in the same driving lane as the ego vehicle) may be referred to as a car behind, a trailing vehicle, or a succeeding vehicle. A target vehicle may be any vehicle that is near the ego vehicle (e.g., within a threshold distance away from the ego vehicle) that the autonomous driving system is monitoring and/or analyzing, either actively or passively. The target vehicle may be, for example, one or more lead vehicles and/or trailing vehicles.

Vehicle control authority (or “vehicle control rights”) is the authority to control at least one component of the vehicle and/or at least one function of the vehicle. The vehicle functions may include at least one among a steering function, an acceleration function, a deceleration function, a braking function, a lane change function, a line detect function, a lateral control function, an object (or obstacle) recognition and distance detection function, a power train control function, a safe area detection function, an engine on/off function, a power on/off function, and a vehicle lock/unlock function. The functions of the vehicle listed are only examples to aid understanding, and the present disclosure is not limited thereto.

A lane is an area of a road where vehicles travel, and is a space designated for vehicles to travel in a single line. A current lane refers to a lane in which the vehicle is driving in real time. For example, if a subject vehicle is driving in lane 2, the current lane for the subject vehicle is lane 2.

An adjacent lane refers to a lane that touches the current lane. For example, on a road with multiple lanes, if the current lane is lane 1, the adjacent lane may be lane 2. For example, if the current lane is lane 2, the adjacent lanes may be lane 1 and lane 3.

A line is a line that separates different lanes from each other. For example, if there are four lanes and four lines, line 1 separates the areas of lane 1 and lane 2, line 2 separates the areas of lane 2 and lane 3, line 3 separates the areas of lane 3 and lane 4, and line 4 separates the areas of lane 4 and a shoulder.

The shoulder is an area located at the edge of a road. The shoulder is a road designed to allow a vehicle to stop in the event of an emergency or to allow an emergency vehicle, such as an ambulance or a police car, to move quickly. In the present disclosure, the term “shoulder” may be used to include a safety zone and a preset area such as a drowsiness rest area or a pocket lane.

An Operation Design Domain (ODD) refers to operating conditions that are specifically designed (or set) for the autonomous driving system to operate. The ODD may be a concept that includes various conditions required to perform autonomous driving functions, such as the surrounding environment during driving, weather conditions, time zone, traffic conditions, road characteristics, vehicle speed, and whether vehicle functions are normal. Some examples of cases that are not within the ODD will be described.

The cases that are outside the ODD may refer to all cases where the vehicle is unable to perform autonomous driving due to internal and/or external causes of the vehicle.

In cases outside the ODD, it may mean all cases where a problem occurs in at least one of the vehicle's driving functions due to internal and/or external causes of the vehicle, or where the vehicle itself is unable to drive.

For example, the case outside the ODD may mean a case where a malfunction occurs in at least one of various functions of the vehicle. For example, it may mean that the malfunction has occurred in at least one of the steering function, acceleration function, deceleration function, braking function, stopping function, lane change function, lane and line detection function, lateral control function, object (or obstacle) recognition and distance detection function, current position measurement function, power train control function, safety zone detection function, engine on/off function, power on/off function, vehicle lock/unlock function, communication function, and autonomous driving function.

For example, the case outside the ODD may mean various cases where the surrounding environment of the vehicle changes while driving. For example, it may mean a case where object recognition using a sensor is impossible or it is difficult for the sensor to operate normally due to weather conditions (e.g. heavy rain, heavy snow, thick fog, backlight, temperature), a case where the road is damaged or in abnormal condition due to a sinkhole or natural disaster (e.g. landslide, flooding), a case where a big accident occurs or an obstacle exists on the road, making it impossible to drive along a normal path, a case where the road is slippery enough to make driving and/or braking difficult (e.g. icy, rainy roads) and where road construction reduces the number of available lanes or requires a detour, etc.

For example, in the case of a Minimal Risk Maneuver (MRM) situation, it is not within the ODD.

Since the contents listed above are merely illustrative, the contents of the ODD according to the present disclosure are not limited by the contents listed above.

In the present disclosure, an enabled or activated state may refer to a standby state where it is ready to perform a specific control. Specifically, when the lane change function of the apparatus 100 is activated, the apparatus 100 may automatically determine whether to perform a lane change. If it is determined that the lane change is required, the apparatus 100 may control the vehicle to perform the lane change.

The Dynamic Driving Task (DDT) may be a concept that includes all tasks required while driving. The DDT may be a concept that includes not only physical operations such as steering, accelerating, and decelerating a vehicle, but also cognitive and judgmental tasks such as sensing and understanding the surrounding environment, planning a driving path, and complying with traffic regulations. The DDT may encompass tasks that assess road and vehicle conditions in real time and respond appropriately.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., receiving a user request to change an autonomous driving mode of the vehicle and/or satisfaction of various conditions) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., receiving a user request to change an autonomous driving mode of the vehicle and/or satisfaction of various conditions) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., receiving a user request to change an autonomous driving mode of the vehicle and/or satisfaction of various conditions) described herein.

Minimum risk maneuver (MRM) operation(s) may also be controlled, for example, based on one or more features (e.g., receiving a user request to change an autonomous driving mode of the vehicle and/or satisfaction of various conditions) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., receiving a user request to change an autonomous driving mode of the vehicle and/or satisfaction of various conditions) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., receiving a user request to change an autonomous driving mode of the vehicle and/or satisfaction of various conditions) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

Depending on the autonomous driving level and mode, the scope of the DDT allocated between a human driver and the autonomous driving system varies.

For autonomous driving levels 1 to 4, it requires human driver performance and intervention in DDT even when the autonomous driving system is in operation. For example, in the case of autonomous driving level 2, the autonomous driving system performs acceleration, deceleration, and steering, but a user (driver) still should monitor and intervene in the overall DDT.

For autonomous driving level 5, the autonomous driving system performs the overall DDT, and driver intervention is unnecessary.

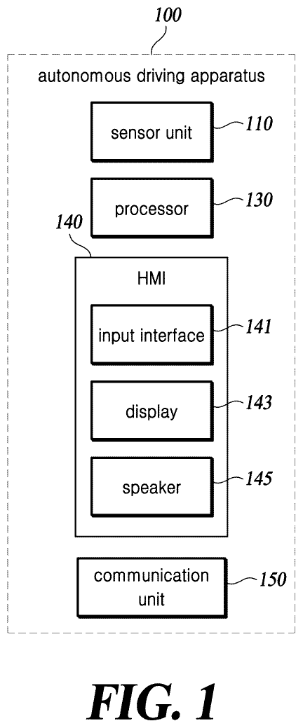

FIG. 1 is a functional block diagram illustrating an autonomous driving apparatus.

Referring to FIG. 1, the autonomous driving apparatus 100 (hereinafter referred to as an “apparatus”) according to the present disclosure may include a sensor unit 110, a processor 130, a Human-Machine Interface (HMI) 140, a communication unit 150, and a memory (not shown). Components that may be included in the apparatus 100 according to the present disclosure are not limited to FIG. 1. It is possible to further include different components that are not shown in FIG. 1.

The apparatus 100 according to the present disclosure can safely change the autonomous driving mode.

The apparatus 100 according to the present disclosure may autonomously determine the status of the vehicle, surrounding conditions, and driving conditions and automatically change the mode, thereby providing a high-quality user experience to the driver.

The apparatus 100 according to the present disclosure may change the autonomous driving mode according to the user's request. The user may conveniently change the mode of the apparatus 100 using an HMI 140.

If the apparatus 100 detects the user's vehicle operation, it may switch to a standby mode, thereby making it possible to clearly allocate the DDT between the human driver and the autonomous driving system. In other words, it is possible to clearly transfer the control authority, thereby reducing the possibility of an accident.

The sensor unit 110 includes at least one sensor. The sensor unit 110 may generate data on each component of the vehicle using at least one sensor. The data on each component of the vehicle (hereinafter referred to as “vehicle data”) may include data on vehicle speed, acceleration, steering angle, brake pad temperature, brake pad wear, engine RPM, remaining fuel level, coolant temperature, tire pressure, engine oil condition, battery voltage, vehicle interior/exterior temperature, vehicle current position, transmission temperature, etc. Vehicle data according to the present disclosure is not limited to the examples described above. The processor 130 may determine whether each component of the vehicle is normal and whether there is a mechanical/electronic failure based on the collected vehicle data.

The sensor unit 110 may detect the surroundings of the vehicle using at least one sensor and generate vehicle surrounding sensing data (hereinafter referred to as “surrounding sensing data”).

The processor 130 may determine a situation around the vehicle based on the collected surrounding sensing data. For example, the processor 130 may analyze the surrounding sensing data to determine weather conditions (heavy rain, heavy snow, thick fog, backlight, temperature, etc.), road conditions (sinkholes, road cracks, black ice, rain, etc.), whether a traffic accident has occurred, whether there is traffic congestion, etc.

The processor 130 may obtain information about objects around the vehicle, such as other vehicles, people, objects, curbs, guardrails, lanes, lines, obstacles, etc., based on surrounding sensing data. Information about objects around the vehicle may include at least one of a position of the object, a size of the object, a shape of the object, a distance to the object, and a relative velocity to the object.

The surrounding sensing data according to the present disclosure is not limited to the example described above.

The processor 130 may determine whether it falls within the ODD based on the surrounding sensing data.

The sensor unit 110 may include a camera, a LIDAR (light detection and ranging), a RADAR (radio detection and ranging), an ultrasonic sensor, an infrared sensor, and a position measurement sensor. The listed sensors are only examples to help understanding, and the sensors of the present disclosure are not limited thereto.

At least one camera may photograph the interior of the vehicle. The camera may photograph a user inside the vehicle to generate user photograph data. The type of the camera is not limited. For example, the camera may be an optical camera, a thermal camera, an infrared camera, etc.

The processor 130 may determine whether the user is in a situation where he or she may drive based on user photograph data. The processor 130 may determine whether to change the autonomous driving mode based on user photograph data. The processor 130 may variably set a mode switching time, which will be described later, based on user photograph data.

The camera may capture the surroundings of the vehicle and generate data about objects located in front, behind, and to the sides of the vehicle.

The LIDAR may use light (or lasers) to generate data about objects located in front, behind, and to the sides of the vehicle.

The RADAR may use electromagnetic waves (or radio waves) to generate data about objects located in front, behind, and to the sides of the vehicle.

The ultrasonic sensor may use ultrasonic waves to generate data about objects located in front, behind, and to the sides of the vehicle. The infrared sensor may use infrared light to generate data about objects located in front, behind, and to the sides of the vehicle.

The sensor unit 110 may measure the current position of the vehicle using a position measuring sensor. The sensor unit 110 may include a GPS (Global Positioning System) sensor, a DGPS (Differential Global Positioning System) sensor, a GNSS (Global Navigation Satellite System) sensor, etc. Vehicle position data may be generated based on a signal generated by the position measuring sensor such as the GPS sensor, the DGPS sensor, and the GNSS sensor.

The apparatus 100 may obtain weather information about the surroundings of the vehicle using the sensor unit 110. For example, the processor 130 may determine whether it is raining based on a signal from a rain sensor.

The processor 130 may control each component of the vehicle. The processor 130 may control the sensor unit 110, the HMI 140, the communication unit 150, etc. The processor 130 may control each component of the vehicle to perform functions such as steering function, acceleration function, deceleration function, braking function, lane change function, line detection function, lateral control function, object (obstacle) recognition and distance detection function, power train control function, and safety zone detection function.

The processor 130 may control the autonomous driving of the vehicle. The processor 130 may determine whether there is an abnormality in a function required for autonomous driving. The functions required for autonomous driving may include, for example, line detection, lane change, lateral control, deceleration (or brake control), power train control, safety zone detection, and object (obstacle) recognition and distance detection.

The processor 130 may determine whether the malfunction has occurred in each component based on a signal received from each component of the vehicle or a signal received from the sensor unit 110.

The processor 130 may control a change in autonomous driving mode. For example, the processor 130 may change from an Adaptive Cruise Control (ACC) mode to a Lane Keeping Assist (LKA) mode. The processor 130 may control a change in autonomous driving level (e.g., SAE autonomous driving level). For example, the processor 130 may change from a mode with autonomous driving level 1 (e.g., SAE autonomous driving level 1) to a mode with autonomous driving level 2 (e.g., SAE autonomous driving level 2).

The processor 130 may determine whether manual change requirements described later are satisfied. The processor 130 may determine whether automatic change requirements described later are satisfied. The processor 130 may determine whether to change the autonomous driving mode depending on whether the manual change requirements and the automatic change requirements are satisfied.

The HMI 140 may include a display 143, a speaker 145, a haptic device (e.g., a steering wheel, a seat, a button, a touch screen), and an input interface 141. The HMI 140 refers to an interface configured to allow a user and a vehicle to interact. The HMI 140 and/or the input interface 141 may be referred to as a user interface.

The HMI 140 may transmit various pieces of information to the user using visual, auditory, and tactile signals. For example, the HMI 140 may perform vehicle speed, autonomous driving start/end guidance, control transfer guidance, autonomous-driving-mode change guidance, real-time driving path guidance, surrounding traffic situation guidance, warning sound output, weather guidance, lane change start (or end) guidance, etc. The components that the HMI 140 according to the present disclosure may include and the functions that the HMI 140 may perform are not limited to the examples listed above.

The user may input commands to control the vehicle using the HMI 140. For example, the user may input commands to control the vehicle using a button, a touch screen, voice recognition function, etc. of the HMI 140.

An input interface 141 of the HMI 140 may include the button, the touch screen, a microphone for voice recognition function, etc. The user may manually request a change in autonomous driving mode using the input interface 141 of the HMI 140. The input interface 141 may generate a mode change request signal through a direct input action of the user. When the mode change request signal is generated, the processor 130 determines whether to change the mode.

The HMI 140 may inform the user whether the autonomous driving mode has changed using visual, auditory, and tactile signals. The HMI 140 may inform the user that the autonomous driving mode has been changed automatically or manually.

If the autonomous driving mode is changed from level 2 (e.g., SAE autonomous driving level 2) to level 3 (e.g., SAE autonomous driving level 3), the HMI 140 may provide the user with information on a section where the autonomous driving level 3 is possible. For example, the HMI 140 may provide guidance such as “Driving at autonomous driving level 3 to a section 3 km away from a current position” using the visual and/or auditory signals.

If the user manually requests the mode change but the mode change is not possible, the HMI 140 may inform the user that the mode change is not possible. If the mode is automatically changed without a user request, the HMI 140 may inform the user that the mode has been changed. If the DDT of the user (driver) is about to increase or if the DDT has increased but the user does not perform the DDT immediately, the HMI 140 may output a warning sound to increase the user's alertness.

The display 143 may display the entire path to a final destination. The display 143 may display a path along which autonomous driving is performed among the entire path. The display 143 may display a path traveled in level 3 autonomous driving mode (hereinafter referred to as “level 3 path”) among the entire path.

If it is determined by the apparatus 100 that the autonomous driving mode is to be changed from level 2 to level 3, the HMI 140 may notify the user of the change in advance before the apparatus 100 changes the mode. After the notice by the HMI 140 is performed, the apparatus 100 changes the mode.

For example, before the apparatus 100 changes the mode, the display 143 may display a section (“level 3 path”) in which the vehicle may be driven in level 3 autonomous driving mode. After the section in which autonomous driving is possible is displayed on the display 143, the apparatus 100 changes the mode. Even after changing the mode, the HMI 140 may display the path for the user on the display 143 or output various guidance sounds using the speaker 145.

The communication unit 150 supports V2X (Vehicle-to-Everything) communication and may communicate with external devices of the vehicle under the control of the processor 130. The communication unit 150 may perform communication using a wireless communication protocol or a wired communication protocol.

Communication interface(s) (also referred to as communication device(s), communicator(s), communication module(s), communication unit(s), etc.) may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Map data is stored in the memory. The map data may be data about roads or detailed maps. For example, the map data may be data about road slope, road width, road length, road curvature, and changes in road curvature. The processor 130 may determine whether the ODD for a specific road is satisfied based on pre-stored map data.

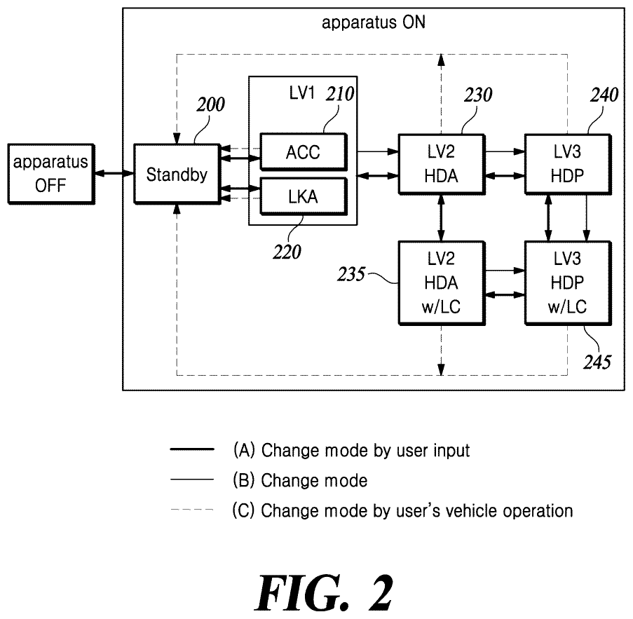

FIG. 2 is a diagram illustrating a change in autonomous driving mode.

Referring to FIG. 2, the apparatus 100 may control the vehicle to perform autonomous driving level 1 to level 3.

The apparatus 100 may perform various modes and change modes along the arrows shown in FIG. 2. The apparatus 100 may perform a standby mode 200, an Adaptive Cruise Control Mode 210 (hereinafter referred to as “ACC mode”), a Lane Keeping Assist Mode 220 (hereinafter referred to as “LKA mode”), a Highway Driving Assist Mode 230 (hereinafter referred to as “HDA mode”), a HDA Mode 235 with Lane Change Function Activated (hereinafter referred to as “HDA w/LC mode”), a Highway Driving Pilot Mode 240 (hereinafter referred to as “HDP mode”), a HDP Mode 245 with Lane Change Function Activated (hereinafter referred to as “HDP w/LC mode”), etc. The modes listed above are only examples for illustration purposes. The types of modes that may be performed by the apparatus 100 according to the present disclosure are not limited to the modes listed above and the modes shown in the drawings.

The standby mode 200 refers to a state in which the apparatus 100 is activated but autonomous driving control is not performed. That is, the standby mode 200 means a state in which the apparatus is ready and waiting to perform autonomous driving control.

Modes in which the apparatus 100 may perform autonomous driving at level 1 include the ACC mode 210, which is a longitudinal control mode, and the LKA mode 220, which is a lateral control mode.

The ACC mode 210 is a longitudinal control mode that controls the longitudinal behavior of the vehicle. The ACC mode 210 is a mode that automatically adjusts a distance from a vehicle in front and adjusts the vehicle speed to the speed set by the driver.

The LKA mode 220 is a lateral control mode that controls the lateral behavior of the vehicle. The LKA mode 220 is a mode that assists the vehicle to maintain the current lane.

In the case of a mode where the autonomous driving level is 1, the apparatus 100 may perform steering control, acceleration control, deceleration control, etc. of the vehicle to assist the driver's DDT. Steering control, acceleration control, deceleration control, etc. may be performed simultaneously or independently. For example, the apparatus 100 may control the behavior of the vehicle using the ACC mode 210, the LKA mode 220, etc. For example, the apparatus 100 may perform longitudinal control of the vehicle using the longitudinal control mode. For example, the apparatus 100 may perform lateral control of the vehicle using the lateral control mode. For example, the apparatus 100 may perform longitudinal and lateral control of the vehicle using the longitudinal and lateral control mode. The longitudinal and lateral control mode is a mode that simultaneously controls the longitudinal and lateral behaviors of the vehicle. In FIG. 2, only the ACC mode 210 and the LKA mode 220 are shown for the mode with autonomous driving level 1, but the mode with level 1 that the apparatus 100 may perform is not limited by FIG. 2. That is, when the apparatus 100 is in a mode where the autonomous driving level is 1, it may perform longitudinal control and lateral control as well as longitudinal and lateral control of the vehicle.

In the case of a mode where the autonomous driving level is 2, the apparatus 100 assists the driver's driving tasks at a higher level than in the mode with level 1. When the level 2 mode is activated, the apparatus 100 may perform all driving tasks, such as steering control, acceleration control, and deceleration control, of the vehicle that may be performed in the level 1 mode, and more actively assists the driving tasks than in the level 1 mode. In the mode where the level is 2, the apparatus 100 may perform longitudinal control, lateral control, longitudinal and lateral control, etc. of the vehicle at a higher level than in the mode where the level is 1. In this way, as the autonomous driving level increases, the level at which the apparatus 100 assists the driver's driving tasks improves, or the types and levels of driving tasks that the apparatus 100 may perform on behalf of the driver increase. For example, in the case of a mode where the autonomous driving level is 3, the apparatus 100 may perform or assist driving tasks at a higher level than in the mode with level 1 and the mode with level 2. In the level 3 mode, the apparatus 100 may perform all driving tasks that may be performed in the level 1 mode and the level 2 mode. In the mode with level 3, the apparatus 100 may perform longitudinal control, lateral control, longitudinal and lateral control, etc. for the vehicle at a higher level than in the mode with level 1 and the mode with level 2.

Modes in which the autonomous driving level that the apparatus 100 may perform is 2 include the HDA mode 230, which is the longitudinal and lateral control mode, and the HDA w/LC mode 235, which is the longitudinal and lateral control mode with a lane change function activated. In the autonomous driving mode of level 2, the driver is responsible for watching the road ahead. When the lane change function is activated, the apparatus 100 may autonomously determine whether to perform the lane change. When the lane change function is activated, the vehicle may change lanes to an adjacent lane under the control of the apparatus 100.

The HDA mode 230 is the longitudinal and lateral control mode. In the HDA mode 230, the apparatus 100 may simultaneously control the longitudinal and lateral behavior of the vehicle. In the HDA mode 230, the vehicle does not change lanes.

The HDA w/LC mode 235 is a mode with a lane change function added to the HDA mode 230. The HDA w/LC mode 235 is a longitudinal and lateral control mode with lane change function activated. The HDA w/LC mode 235 may simultaneously control the longitudinal and lateral behavior of the vehicle. In the HDA w/LC mode 235, the vehicle may autonomously change lanes.

Modes in which the autonomous driving level that the apparatus 100 may perform is 3 include the HDP mode 240, which is the longitudinal and lateral control mode, and the HDP w/LC mode 245, which is the longitudinal and lateral control mode with a lane change function activated. In the mode in which the autonomous driving level is 3, the driver is not obligated to keep his or her eyes forward.

The HDP mode 240 is the longitudinal and lateral control mode. In the HDP mode 240, the apparatus 100 may simultaneously control the longitudinal and lateral behavior of the vehicle. In the HDP mode 240, the vehicle does not change lanes.

The HDP w/LC mode 245 is a mode with a lane change function added to the HDP mode 240. The HDP w/LC mode 245 is a longitudinal and lateral control mode with lane change function activated. The HDP w/LC mode 245 may simultaneously control the longitudinal and lateral behavior of the vehicle. In the HDP w/LC mode 245, the vehicle may autonomously change lanes.

As in A of FIG. 2, the mode of the apparatus 100 may be changed by user input. As in B of FIG. 2, the mode of the apparatus 100 may be automatically changed according to the determination of the processor 130. As in C of FIG. 2, the mode of the apparatus 100 may be changed to the standby mode 200 by the user's vehicle operation.

If the mode is changed by user input (A in FIG. 2) or automatically changed according to the determination of the processor 130 (B in FIG. 2), the level of autonomous driving may only be changed sequentially. For example, if the autonomous driving level is 1, it may not be changed to level 3 mode at once. When changing from the level 1 autonomous driving mode to the level 3 mode, the level 1 mode should be changed to a level 2 mode, and then the level 2 mode should be changed to the level 3 mode.

If the mode is changed by the user's vehicle operation (C in FIG. 2), the changed mode may be the standby mode 200, for example, regardless of a currently operating mode. Instead of changing the level/mode sequentially, the standby mode 200 may be selected, for example, regardless of the current level/mode. This may prevent the driver's confusion during the transfer of control.

Specifically, if a preset vehicle operation by the user is detected, the processor 130 may change the mode of the apparatus 100 to the standby mode 200 (C in FIG. 2). Preset vehicle operations may include acceleration, braking, and steering operations.

If a user performs vehicle operations such as acceleration, braking, and steering, the apparatus 100 changes to the standby mode 200 (C in FIG. 2), and the DDT assigned to the apparatus 100 is retrieved and assigned to the user. In the standby mode 200, the user has priority over vehicle control and performs all driving tasks (DDT). For example, in the HDP mode 240, if the user steps on the brake pedal, the mode is changed to the standby mode 200 at once, and all driving tasks (DDT) assigned to the apparatus 100 are retrieved and assigned to the user.

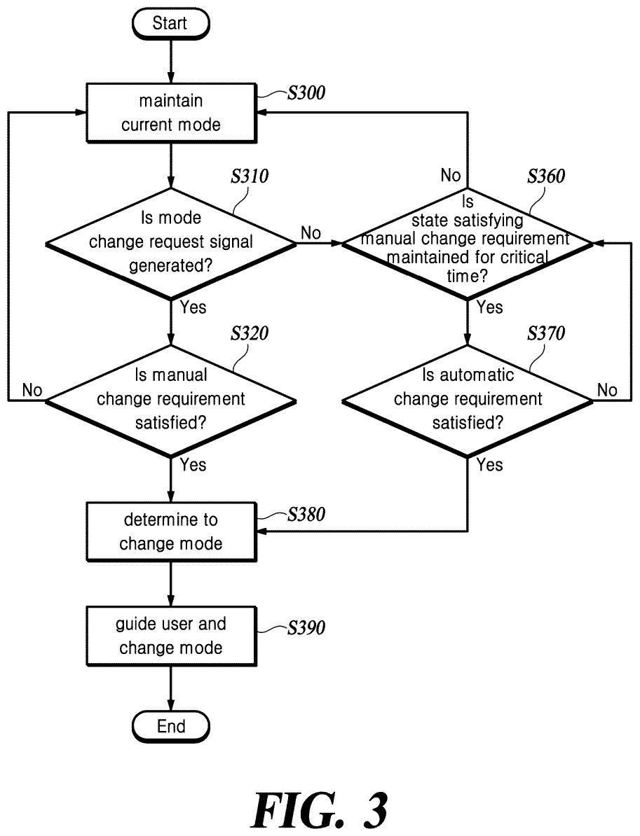

FIG. 3 is a flowchart illustrating a method of controlling an autonomous driving apparatus.

Referring to FIGS. 2 and 3, the apparatus 100 performs steps S300 to S390 when changing the mode.

The apparatus 100 maintains a current mode at S300. The current mode may be any one of the modes shown in FIG. 2. The current mode is not limited to the modes shown in FIG. 2. Unless a situation arises where autonomous driving is impossible, such as when entering a highway on-ramp/off-ramp, the processor 130 controls the apparatus 100 to maintain the current mode.

The processor 130 determines whether a mode change request signal has occurred at S310. When a user requests a mode change of the apparatus 100 using the input interface 141 of the HMI 140, the input interface 141 of the HMI 140 generates a mode change request signal. For example, when a user presses a button on the input interface 141 to change from the standby mode 200 to the ACC mode 210, the input interface 141 generates the mode change request signal.

Hereinafter, the case where a mode change request signal is generated from the input interface 141 (yes at S310) will be first described, and the case where no mode change request signal is generated (no at S310) will be described.

If the mode change request signal is generated from the input interface 141 (yes at S310), the processor 130 determines whether the manual change requirement is satisfied at S320. If the manual change requirement is satisfied, the processor determines to change the mode, at S380. If it is determined to change the mode at S380, the HMI 140 may provide guidance to the user about the mode change and guidance about the section to which the changed mode is applied at S390, and the processor 130 may change the mode before and/or after the guidance by the HMI 140 is performed at S390. Mode change by the processor 130 may also be performed simultaneously with guidance from the HMI 140, at S390. The display 143 and/or the speaker 145 may provide guidance on the timing of the mode change, a notice of the mode change, guidance on which mode is being changed to, guidance that the mode change is complete, guidance on the entire path, guidance on a path on which autonomous driving may be performed, etc. at S390.

For example, in the mode where the autonomous driving level is 1, if the mode change request signal is generated to change the mode to the autonomous driving level 2 mode (yes at S310), the processor 130 may determine whether the first manual change requirement for changing to level 2 mode is satisfied at S320. If the first manual change requirement is satisfied, the processor 130 may determine to change the mode at S380. The first manual change requirements for changing from a first autonomous driving mode (e.g., the mode with autonomous driving level 1) to a second autonomous driving mode (e.g., the mode with autonomous driving level 2) may include the longitudinal control mode being activated, the lateral control mode being activated, a maximum value set as the operating speed of the longitudinal control mode (e.g., a cruise control speed of the vehicle) being less than the speed limit of the road on which a vehicle is being driven (e.g., a posted speed limit), the road which a vehicle is driving on being a predetermined type of road (e.g., a highway, an expressway), etc. The above description is merely illustrative, and the first manual change requirement is not limited to the above listed items.

For example, in the mode where the autonomous driving level is 2, if the mode change request signal is generated to change the mode to the autonomous driving level 3 mode (yes at S310), the processor 130 determines whether the second manual change requirement for changing to level 3 mode is satisfied at S320. If the second manual change requirement is satisfied, the processor 130 may determine to change the mode at S380. The second manual change requirement required by the user to change from the mode with autonomous driving level 2 to the mode with autonomous driving level 3 may include requirements such as the requirement that the longitudinal and lateral control mode should be activated, the requirement that the sensors of the sensor unit 110 that detect the surroundings of the vehicle and the sensor thereof that detects the status of the vehicle are third level sensors and are in a normal state, etc.

In order to maintain the autonomous driving level 3 mode, each sensor of the sensor unit 110 should meet stricter requirements in terms of function and performance compared to when the autonomous driving level 2 mode is maintained. For example, to maintain the level 3 mode, the sensor's detection range, performance, types of data that may be collected, amount of data that may be collected, data processing speed, etc. should be qualitatively and/or quantitatively higher than in the level 2 mode. This is because level 3 should be able to perform autonomous driving in more complex situations or conditions than level 2. In other words, the higher the autonomous driving level, the higher specification sensor is required.

A first level sensor is a sensor that meets the requirements for maintaining autonomous driving level 1 mode. A second level sensor may be a sensor that meets the requirements for maintaining autonomous driving level 2 mode. The second level sensor has higher specifications than the first level sensor. A third level sensor may refer to a sensor that meets the requirements to maintain autonomous driving level 3 mode. The third level sensor has higher specifications than the second level sensor.

The above description is merely illustrative, and the second manual change requirement is not limited to the above listed items.

If it is determined to change the mode in response to the mode change request signal at S380, the processor 130 may set a mode switching time. The mode switching time may be the time required for the mode change to be completed. In other words, the mode switching time may be a time duration (e.g., an upper bound) which the mode change is to take place in. After the mode switching time has passed, the processor 130 changes the mode. For example, if it is determined to change from the HDP mode 240 to the HDA mode 230 according to the mode change request signal at S380, the processor 130 may not change to the HDA mode 230 immediately, but change to the HDA mode 230 after the mode switching time has elapsed. The mode switching time may be, for example, a grace period for mode changes. During the mode switching time, a user may prepare for an increase in DDT due to a decrease in the level of autonomous driving in operation.

The processor 130 may variably set the mode switching time based on user photograph data. The user photograph data (e.g., image data) may be data generated by a camera that is provided inside the vehicle to photograph the user. The processor 130 may analyze the user photograph data to determine whether the user is ready for an increase in driving tasks. For example, if it is determined that the requirements required of the user are not satisfied when driving tasks increase, such as when the user is not sitting in the designated position in the driver's seat or is dozing off, the processor 130 may set the mode switching time to be long. In order to prevent the mode from being changed until the user's requirements are satisfied when driving tasks increase, the processor 130 may also set the mode switching time to infinity. If it is determined that the user is ready for increased driving tasks, the processor 130 may reset the mode switching time and changes the mode after the mode switching time has elapsed.

If the mode change request signal does not occur (no at S310), the processor 130 determines whether a state satisfying the manual change requirement is maintained for a critical time (e.g., a threshold time duration) at S360 and whether the automatic change requirement is satisfied at S370. If the state satisfying the manual change requirement is maintained for the critical time (e.g., a threshold time duration) and the automatic change requirement is satisfied, the processor 130 may determine to automatically change the mode of the apparatus 100 at S380. If it is determined to automatically change the mode at S380, the HMI 140 may provide guidance to the user about the automatic change of the mode, guidance about a section to which the automatically changed mode is applied, etc. at S390. The processor 130 may automatically change the mode before and/or after guidance by the HMI 140 at S390. The automatic mode change by the processor 130 may also be performed simultaneously with guidance from the HMI 140 at S390. The display 143 and/or the speaker 145 may provide guidance on when an automatic mode change is performed, a notice on the automatic mode change, guidance on which mode is automatically changed, guidance that the automatic change is complete, guidance on the entire path, guidance on the path along which the mode is automatically changed, etc. at S390.

The automatic change means a case where the processor 130 of the apparatus 100 autonomously determines whether to change the mode and autonomously performs the change of mode. That is, the automatic change is a mode change that the apparatus 100 automatically performs when there is no request for the mode change by the user.

For example, in order for the processor 130 to determine to automatically change the autonomous driving level 1 mode to the autonomous driving level 2 mode, the state satisfying the first manual change requirement described above should be maintained for the critical period time (yes at S360), and the first automatic change requirement should be satisfied (yes at S370). The first manual change requirement may include requirements such as the requirement that each of the longitudinal control mode and the lateral control mode should be activated, the requirement that the maximum value set as the operating speed of the longitudinal control mode should be less than the speed limit of the road on which a vehicle is being driven, the requirement that the road on which a vehicle is being driven should be a preset road (e.g., highway, expressway), etc. The above description is merely illustrative, and the first manual change requirement is not limited to the above listed items. The first automatic change requirement may be identical to the first manual change requirement. If the first automatic change requirement is the same as the first manual change requirement and a state in which the first manual change requirement is satisfied is maintained for the critical time (e.g., a threshold time duration) at S360, the processor 130 may determine to automatically change the mode of the apparatus 100 to the mode with the autonomous driving level of 2 at S380.

The apparatus 100 automatically changes the mode only when it is not a minimal risk maneuver (MRM) situation. In the case of the MRM situation, the processor 130 does not automatically change the mode of the apparatus 100. The MRM may refer to a case where autonomous driving is performed but a problem occurs in the vehicle or the external environment, making it difficult to continue autonomous driving, or may refer to a vehicle operation method to minimize the occurrence of an accident, such as changing lanes or stopping the vehicle.

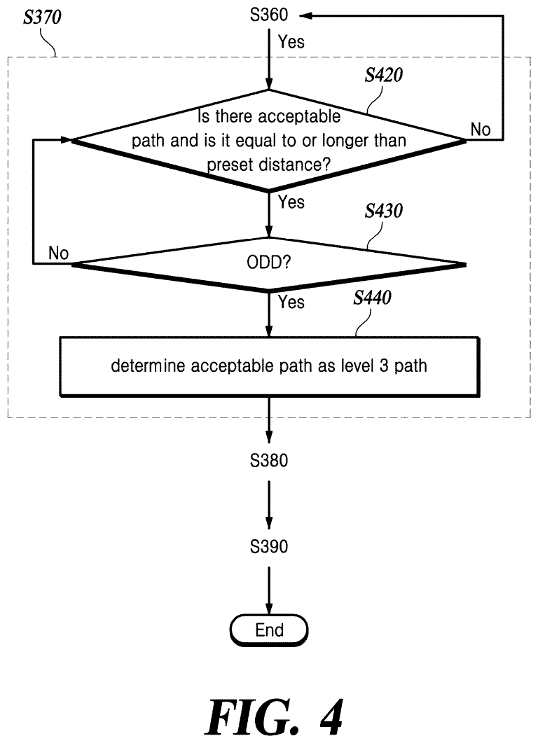

FIG. 4 is a flowchart that initiates processes S360, S370, S380, and S390 of FIG. 3, and illustrates a process when automatically changing from an autonomous driving mode at level 2 to an autonomous driving mode at level 3.

Referring to FIGS. 2 to 4, in order for the mode of the apparatus 100 to automatically change from the mode of autonomous driving level 2 to the mode of autonomous driving level 3, a state satisfying the second manual change requirement should be maintained for a critical time (e.g., a threshold time duration) at S360, and the second automatic change requirement should be satisfied at S370.

The second manual change requirement in process S360 of FIG. 4 is the same as that described in process S360 of FIG. 3. That is, the second manual change requirement may include requirements such as the requirement that the longitudinal and lateral control mode should be activated, the requirement that the sensor detecting the surroundings of the vehicle and the sensor detecting the status of the vehicle among the sensors of the sensor unit 110 are third level sensors and are in a normal state, etc. The above description is merely illustrative, and the second manual change requirement is not limited to the above listed items.

Each of processes S420 to S440, which are sub-processes of process S370, will be described.

The processor 130 determines whether both the requirement that there is an acceptable path among the entire path to a final destination (e.g., at least part of a path to a final destination being suitable) and the requirement that the acceptable path should be longer than a preset distance (e.g., a length of the section being greater than or equal to a threshold distance) are satisfied at S420. In the present disclosure, the term “acceptable path” refers to a path on which driving in autonomous driving mode at level 3 is expected to be possible.

A user may input the final destination using the HMI 140, and the processor 130 may calculate the entire path corresponding to the final destination.

The processor 130 may determine whether the acceptable path exists among the entire path using pre-stored map data, a high-definition map, real-time road information collected by the communication unit 150, etc.

If the acceptable path does not exist or the acceptable path is less than a preset distance, the processor 130 determines that the second automatic change requirement at S370 is not satisfied (no at S420).

If the acceptable path exists and the acceptable path is equal to or longer than the preset distance (yes at S420), the processor 130 determines whether the acceptable path satisfies the requirement that it be the ODD at S430.

The processor 130 may determine whether the acceptable path is the ODD based on pre-stored map data. The pre-stored map data may be high-definition map data including data on the curvature of the entire path, data on the amount of change in curvature of the entire path, etc. If there is no or insufficient data on the current driving path in the pre-stored map data, the processor 130 may determine that the acceptable path is not the ODD (no at S430). If it is determined that it is not the ODD (no at S430), the processor 130 performs process S420 again, but performs process S420 based on an acceptable path different from the existing acceptable path.

The processor 130 may determine whether the acceptable path is within the ODD based on traffic condition data. The traffic condition data is data obtained by the communication unit 150 through communication with the external device and/or external infrastructure. The traffic condition data may refer to data on weather conditions, road conditions, traffic accidents, traffic flow, road construction, etc. The traffic condition data according to the present disclosure is not limited to the examples described above.

The processor 130 may determine the situation surrounding the vehicle in real time based on surrounding sensing data (e.g., environment data generated by detecting a surrounding environment of the vehicle) and determine whether the acceptable path is within the ODD.

For example, the processor 130 may analyze weather conditions (heavy rain, heavy snow, thick fog, backlight, temperature, etc.), road conditions (sinkholes, road cracks, black ice, rain, etc.), traffic accident occurrence, objects around the vehicle (e.g., other vehicles, people, objects, curbs, guardrails, lanes, lines, obstacles, etc.), traffic congestion, etc. based on surrounding sensing data, and may determine whether the acceptable path is within the ODD.

For example, the processor 130 may analyze information about objects (e.g., other vehicles, people, objects, curbs, guardrails, lanes, lines, obstacles, etc.) around the vehicle based on surrounding sensing data and determine whether the acceptable path is within the ODD.

If the acceptable path is within the ODD (yes at S430), the processor 130 may determine the acceptable path as a level 3 path at S440. The level 3 path means a path that has been determined by the processor 130 to be capable of driving in autonomous driving mode at level 3. When driving on the level 3 path, the processor 130 may control the vehicle in HDP mode 240.

If the acceptable path is determined to be the level 3 path at S440, the processor 130 may determine to automatically change the mode of the apparatus 100 to a mode with the autonomous driving level of 3 when driving on the level 3 path, at S380.

If the processor 130 determines to automatically change the mode of the apparatus 100 to the mode with autonomous driving level 3 at S380, the HMI 140 may provide guidance to the user on the automatic mode change, guidance on level 3 path, etc. at S390. The processor 130 may automatically change the mode before and/or after guidance by the HMI 140 is performed at S390. The automatic mode change by the processor 130 may also be performed simultaneously with guidance from the HMI 140, at S390. The display 143 and/or the speaker 145 may provide guidance on when the automatic mode change is performed, guidance on changing to autonomous driving level 3, guidance that the automatic mode change is complete, guidance on the entire path, guidance on the level 3 path, etc. at S390. The display 143 may display a level 3 path.

The apparatus 100 may automatically change the mode to the autonomous driving mode with level 3 only when it is not an MRM situation (e.g., the vehicle is not in the MRM situation). In the case of the MRM situation, regardless of whether the state satisfying the second manual change requirement is maintained for the critical time (e.g., a threshold time duration) at S360 and whether the second automatic change requirement S370 is satisfied, the processor 130 does not automatically change the mode of the apparatus 100 to the mode with the autonomous driving level of 3.

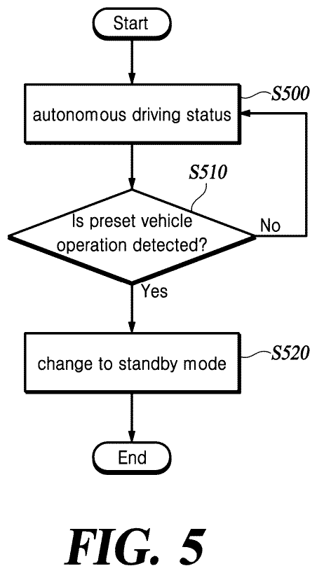

FIG. 5 is a flowchart illustrating a process of changing to a standby mode.

Referring to FIG. 5, the apparatus 100 may be in an autonomous driving state at S500. Specifically, as shown in FIG. 2, the processor 130 may control the apparatus 100 to perform the mode in which autonomous driving level is 1 or the mode in which autonomous driving level is 3.

In the autonomous driving state S500, the processor 130 may detect/determine whether the user has performed a preset vehicle operation at S510. The preset vehicle operations may be acceleration, braking, steering operations, etc.

For example, when a user steps on the accelerator pedal or brake pedal, or operates the steering wheel, the processor 130 determines that the user has performed the preset vehicle operation. The preset vehicle operations of the present disclosure are not limited to the above examples.

When the processor 130 detects/determines that the preset vehicle operation has been performed by the user at S510, the processor 130 changes the mode of the apparatus 100 to standby mode (S520, C in FIG. 2). That is, when the user performs vehicle operations such as acceleration, braking, and steering, the apparatus 100 changes to the standby mode 200.

When changing to the standby mode 200, all the DDT assigned to the apparatus 100 may be retrieved and transferred to the user. That is, the DDT of the user increases. In the standby mode 200, the user has priority over vehicle control and performs all driving tasks (DDT). For example, in the HDP mode 240, if the user steps on the brake pedal, the mode is switched to the standby mode 200, and the DDT assigned to the apparatus 100 is retrieved and transferred to the user.

As such, if the preset vehicle operation by the user is detected and the vehicle is changed to the standby mode 200, it may be changed to the standby mode 200 at once regardless of the level of the current autonomous driving mode. For example, if the mode is changed from the mode with the autonomous driving level of 3 to the standby mode 200, the mode is changed directly from the mode of level 3 to the standby mode 200 without going through the mode of level 2 or the mode of level 1 (C in FIG. 2). The same applies to a case where the mode is changed from the mode with the autonomous driving level of 2 to the standby mode 200. If the preset vehicle operation by the user is detected, the mode may be changed directly from the mode with the autonomous driving level of 2 to the standby mode 200. That is, the mode is changed to the standby mode 200 without going through the mode with the autonomous driving level of 1.

Referring to FIGS. 2 and 3, the mode of the apparatus 100 may be automatically changed from the HDP mode 240 to the HDP w/LC mode 245. In order for the mode of the apparatus 100 to automatically change from the HDP mode 240 to the HDP w/LC mode 245, requirements for performing the HDP mode 240 should be satisfied, and in addition, requirements for activating lane change should be satisfied.

The lane change activation requirements may include requirements such as the requirement that a lane change acceptable path should exist in the entire path to the final destination, the requirement that the lane change acceptable path should be equal to or longer than a preset distance, the requirement that the lane change acceptable path should be within the ODD, and the requirement that it should not be the MRM situation.

In the present disclosure, the term “lane change acceptable path” means a path on which driving is expected to be possible in “autonomous driving level 3 mode with the lane change function activated.”

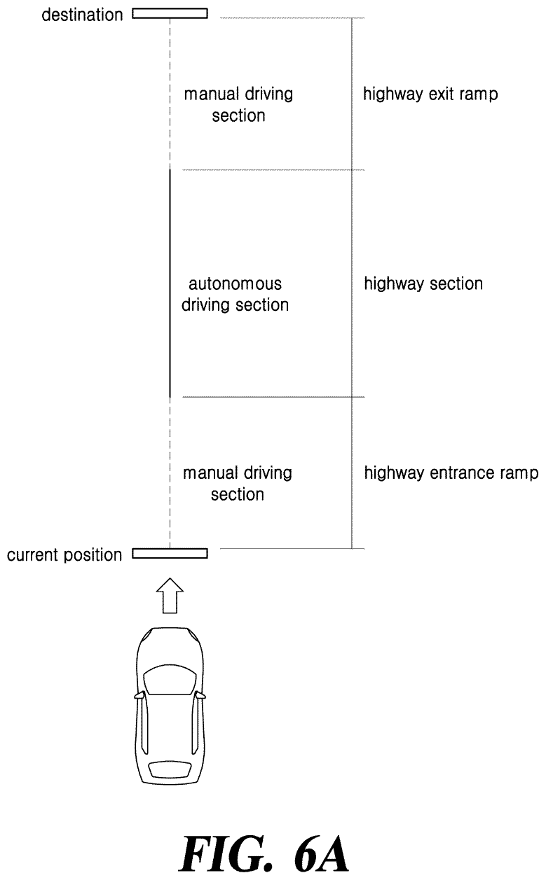

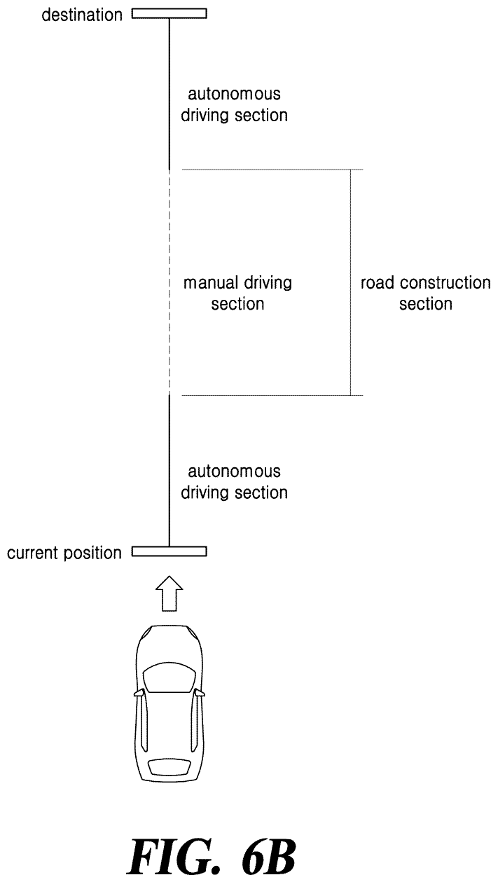

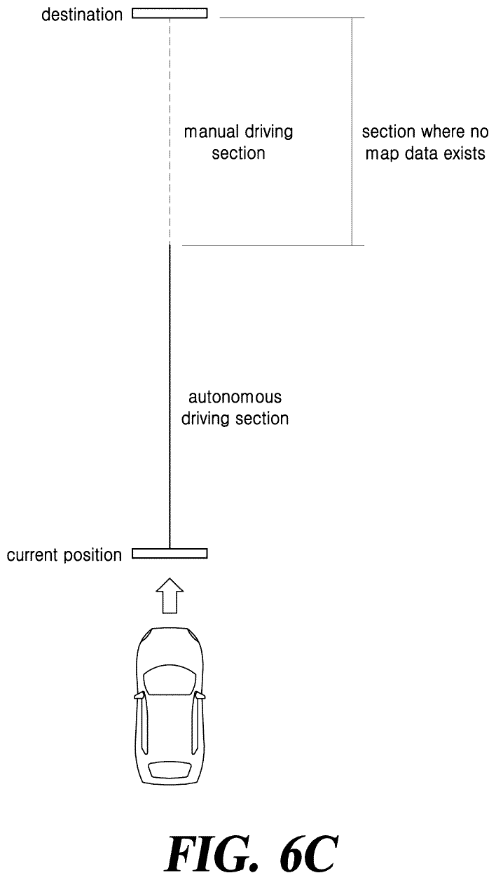

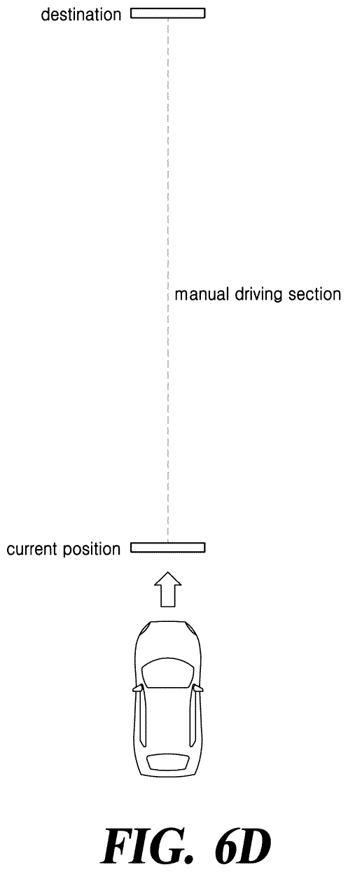

FIGS. 6A, 6B, 6C, and 6D illustrate a driving method on a highway.

FIG. 6A is a diagram illustrating a driving method when highway entrance and exit ramps are included in an entire path.

Referring to FIG. 6A, manual driving by human drivers is required on the highway entrance and exit ramps. This is because the highway entrance and exit ramps are not the ODD and require the user (human driver) to perform driving tasks (DDT).

In the case of the highway section excluding the highway entrance and exit ramps, the apparatus 100 may perform modes with autonomous driving levels 1 to 4 in consideration of the ODD. Compared to the highway entrance and exit ramps, the highway section has no intersections, traffic lights, or pedestrians, and is relatively constant in the flow of traffic, making road conditions more predictable and requiring a user to perform driving tasks relatively less.

FIG. 6B is a diagram illustrating a driving method when a road construction section is present in the entire path.

Referring to FIG. 6B, the manual driving by the human driver is required in the road construction section along the entire path. To avoid the road construction section, the user's driving task (DDT) should be performed. If it is not the road construction section and is a section that satisfies the ODD, the apparatus 100 may maintain the autonomous driving mode.

FIG. 6C is a diagram illustrating a driving method when there is a section in the entire path where no map data is present.

Referring to FIG. 6C, the section where no map data exists along the entire path does not satisfy the ODD, so manual driving by the human driver is required. If there is map data in the section and the section satisfies the ODD, the apparatus 100 may maintain the autonomous driving mode.

FIG. 6D is a diagram illustrating a case where a vehicle is manually driven on the entire section along the entire path.

Referring to FIG. 6D, the user's DDT is required for the entire section. For example, if the ODD is not satisfied for the entire section or if it is an MRM situation, manual driving by the human driver is required, rather than autonomous driving of the vehicle.

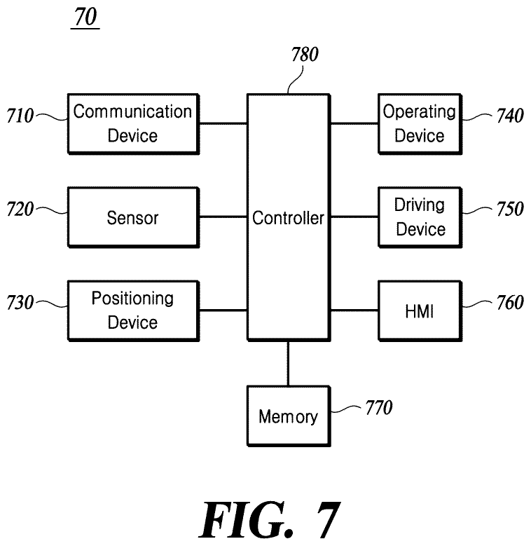

FIG. 7 is a block diagram schematically illustrating an exemplary vehicle system that may be used to implement the method or apparatus described in the present disclosure.

Referring to FIG. 7, the vehicle 70 includes at least one of a communication device 710, a sensor 720, a positioning device 730, an operating device 740, a driving device 750, an HMI 760, a memory 770, and a controller 780. The vehicle 70 may structurally and/or functionally include the apparatus 100. The vehicle 70 may correspond to the vehicle 100 described above. The communication device 710 may exchange signals with devices located outside and inside the vehicle 70. The communication device 710 may exchange signals with at least one of an infrastructure device such as a server or a base station, another vehicle, and a terminal. The communication device 710 may include at least one of a transmitting antenna, a receiving antenna, an RF (Radio Frequency) circuit capable of implementing various communication protocols, and an RF element to perform communication. The communication device 710 may include an internal communication unit and an external communication unit. The internal communication unit may transmit or receive signals using various communication protocols existing within the vehicle 70. The internal communication protocol may include at least one of CAN (Controller Area Network), CAN FD (CAN with Flexible Data rate), Ethernet, LIN (Local Interconnect Network), and FlexRay. The communication protocol may include other protocols for communication between various devices mounted on the vehicle. The external communications part may communicate with other vehicles, infrastructure systems, base stations, roadside equipment, etc. using various communication protocols. The external communication protocol may include vehicle-to-vehicle (V2V) communication, vehicle-to-infrastructure (V2I) communication, vehicle-to-network (V2N) communication, and vehicle-to-everything (V2X) communication including vehicle-to-pedestrian (V2N) communication. The infrastructure may be a roadside unit or server that periodically transmits traffic information in conjunction with, for example, a Transportation Information System (TIS) or an Intelligent Transport System (ITS).

The sensor 720 may sense the status of the vehicle 70 and external objects.

The sensor 720 may include at least one of an IMU (inertial measurement unit), a DMI (distance measuring instrument) device, a collision sensor, a wheel sensor, a speed sensor, an inclination sensor, a weight detection sensor, a heading sensor, a position module, a vehicle forward/backward sensor, a battery sensor, a fuel sensor, a tire sensor, a steering sensor, a temperature sensor, a humidity sensor, an ultrasonic sensor, a luminance sensor, and a pedal position sensor to sense the status of the vehicle 70. Meanwhile, the IMU sensor may include one or more of an acceleration sensor, a gyro sensor, and a magnetic sensor. The sensor 720 may generate vehicle status data, based on a signal generated from at least one sensor. For example, direction information such as heading and yaw rate of the vehicle 70 may be collected by the sensor 720.

The sensor 720 may include at least one of a camera, a radar sensor, a Light Detection and Ranging (LiDAR) sensor, an ultrasonic sensor, and an infrared sensor to detect external objects. The sensor 720 may measure at least one of information on the presence or absence of an object, information on the position of the object, information on the distance between the vehicle 70 and the object, and information on relative speed between the vehicle 70 and the object.

The positioning device 730 may generate location data of the vehicle 70. The positioning device 730 may include at least one of a Global Positioning System (GPS), a Differential Global Positioning System (DGPS), or a Global Navigation Satellite System (GNSS). The positioning device 730 may generate location data of the vehicle 70 based on a signal generated from at least one of GPS, DGPS, or GNSS. The positioning device 730 may estimate the location of the vehicle 70 based on wireless signals received from the communication device 710. The positioning device 730 may estimate the current position of the vehicle 70 based on the previous position, moving distance information, moving time information, speed information, or acceleration information of the vehicle 70 using an IMU or DMI. Meanwhile, based on the location information of the vehicle 70 collected by the positioning device 730, the controller 780 may estimate the path history and path prediction of the vehicle 70.

The operating device 740 receives user input for driving. In the manual mode, the vehicle 70 may be driven based on a signal provided by the operating device 740. The operating device 740 may include a steering input device such as a steering wheel, an acceleration input device such as an accelerator pedal, and a brake input device such as a brake pedal.

The driving device 750 is a device that electrically controls various vehicle driving devices within the vehicle 70. The driving device 750 may include a power train driving control device, a chassis driving control device, a door/window driving control device, a safety device driving control device, a lamp driving control device, and an air conditioning driving control device. The driving device 750 controls the movement of the vehicle 70 based on an input signal of the operating device 740 or a control signal of the controller 780.

The HMI 760 is a device for communication between the vehicle 70 and a person (e.g., a passenger of the vehicle 70 or another vehicle). The HMI 760 may receive input from a user and provide information generated in the vehicle 70 to the user. The vehicle 70 may implement a user interface (UI) or a user experience (UX) through the HMI 760. The HMI 760 may include input devices such as a touch panel, a microphone, etc., and may include output devices such as a display device, a speaker, etc. For example, the HMI 760 may include an internal display that outputs a screen toward the inside of the vehicle and/or an external display that outputs the screen toward the outside of the vehicle.

The memory 770 may store a program that causes the controller 780 to perform a method. For example, the program may include a plurality of commands executable by the processor, and a method may be performed by executing the plurality of commands using the processor.

The memory 770 may be a single memory or multiple memories. If the memory 770 is composed of the multiple memories, the multiple memories may be physically separated. The memory 770 may include at least one of volatile memory and non-volatile memory. The volatile memory includes SRAM (Static Random Access Memory) or DRAM (Dynamic Random Access Memory), and the non-volatile memory includes flash memory.

The memory 770 stores map information. The map information may be either a navigation map and/or a high definition (HD) map. The HD map may be received from the external device or may be stored in advance. The navigation map may include geographic information, road information, lane information, building information, or signal information. The HD map contains more specific data than the navigation map. The HD map may include, at the road level, information such as road slopes, road curvature, and traffic signs. The HD map may include, at the lane level, lane information, lane boundary information, stop line locations, traffic light locations, signal sequences, or intersection information. The HD map may include basic road information, surrounding environment information, detailed road environment information, or dynamic road condition information. The detailed road environment information may include static information such as terrain elevation, curvature, lanes, lane centerlines, regulatory lines, road boundaries, road centerlines, traffic signs, road markings, road shape and height, and lane width. The dynamic road condition information may include traffic congestion, accident sections, and construction sections. The HD map may include information about the surrounding road environment implemented in 3D, geometric information such as road shape or facility structure, and semantic information such as traffic signs or line marks.

The controller 780 may include at least one core capable of executing at least one command. The controller 780 may execute commands stored in the memory 770. The controller 780 may be a single processor or multiple processors.

Each component of the apparatus or method according to the present disclosure may be implemented by hardware or software, or may be implemented by a combination of hardware and software. In addition, a function of each component may be implemented in software, and a microprocessor may be implemented to execute a function of the software corresponding to each component.

Various implementations of the systems and techniques described herein may be realized in digital electronic circuitry, integrated circuitry, field programmable gate arrays (FPGAs), application specific integrated circuits (ASICs), computer hardware, firmware, software, and/or combinations thereof. These various implementations may include implementation in one or more computer programs that are executable on a programmable system. The programmable system includes at least one programmable processor (which may be a special-purpose processor or a general-purpose processor) coupled to receive data and commands from, and to transmit data and commands to, storage systems, at least one input device, and at least one output device. Computer programs (also known as programs, software, software applications, or code) include commands for a programmable processor and are stored in a “computer readable recording medium”.

The computer-readable recording medium includes all kinds of recording devices in which data that may be read by a computer system is stored. The computer-readable recording medium may be a non-volatile or non-transitory medium such as ROM, CD-ROM, magnetic tape, floppy disc, memory card, hard disc, magneto-optical disc, or storage device, and may further include transitory medium such as data transmission medium. In addition, the computer-readable recording medium may be distributed in a network-connected computer system, and the computer-readable code may be stored and executed in a distributed manner.

An apparatus configured to control autonomous driving of a vehicle and to control a mode of the autonomous driving of the vehicle, the apparatus comprising: input interface for manually receiving a request from a user to change the mode; and a processor determining whether to change the mode depending on whether a manual change requirement and an automatic change requirement are satisfied, and controlling the mode change, wherein the processor determines to change the mode when a mode change request signal is generated from the input interface and the manual change requirement is satisfied, and wherein the processor determines to automatically change the mode when no mode change request signal is generated from the input interface, a state in which the manual change requirement is satisfied is maintained for a critical time (e.g., a threshold time duration), and the automatic change requirement is satisfied.

A method of controlling autonomous driving of a vehicle and controlling a mode of the autonomous driving of the vehicle, the method comprising: determining by a processor to change the mode if a manual change requirement is satisfied, when a mode change request signal is generated from input interface by a user; and determining to automatically change the mode if a state in which the manual change requirement is satisfied is maintained for a critical time and the automatic change requirement is satisfied, when no mode change request signal is generated from the input interface.

In the flowcharts/timing diagrams of the present specification, each process is described as being executed sequentially, however, this is merely an example of the technical idea of one or more example embodiments of the present disclosure. In other words, the flowcharts/timing diagrams are not limited to a chronological order, as those skilled in the art may make various modifications and variations to the sequence of the flowchart/timing diagram or to perform one or more of the processes in parallel without departing from the essential characteristics of the example embodiments of the present disclosure.

The foregoing descriptions are merely illustrative of the technical idea of the present example embodiments, and various modifications and variations may be made by those skilled in the art without departing from the essential characteristics of the present example embodiments. Therefore, the present example embodiments are not intended to limit the technical idea of the present disclosure, but are intended to be illustrative, and the scope of the technical idea of the present disclosure is not limited by these example embodiments. The protection scope of the present disclosure is to be construed according to the following claims, and all technical ideas within the scope equivalent thereto are construed as being included in the scope of rights of the present disclosure.

What is claimed is:

1. An apparatus of a vehicle, the apparatus comprising:
an input interface configured to receive, from a user, a user request to change an autonomous driving mode of the vehicle;
a processor; and
a memory storing at least one instruction that is configured, when executed by the processor communicating with the memory, to cause the apparatus to:
change, based on the input interface receiving the user request within a threshold time duration and based on a manual mode change requirement being satisfied, the autonomous driving mode from a first mode to a second mode;
change, based on the input interface receiving no user request within the threshold time duration, based on the manual mode change requirement being satisfied during the threshold time duration, and based on an automatic mode change requirement being satisfied, the autonomous driving mode from the first mode to the second mode; and
control the vehicle to perform an autonomous driving operation of the second mode.

2. The apparatus of claim 1, wherein the first mode comprises an autonomous driving level 1, wherein the second mode comprises an autonomous driving level 2, and wherein the manual mode change requirement comprises at least one of:
a road on which the vehicle is driving being a predetermined type of road,
activation of a longitudinal control mode of the vehicle and a lateral control mode of the vehicle, or
a maximum operating speed that is set for the longitudinal control mode being less than a posted speed limit.

3. The apparatus of claim 1, wherein the first mode comprises an autonomous driving level 2, wherein the second mode comprises an autonomous driving level 3, and wherein the manual mode change requirement comprises at least one of:
activation of a longitudinal control mode of the vehicle and a lateral control mode of the vehicle, or
a first sensor detecting a surrounding environment of the vehicle and a second sensor detecting a status of the vehicle are in a normal state, wherein the first sensor and the second sensor satisfy requirements associated with the autonomous driving level 3.

4. The apparatus of claim 1, wherein the at least one instruction is configured, when executed by the processor, to further cause the apparatus to change, based on detecting a predetermined vehicle operation performed by the user, the autonomous driving mode to a standby mode.

5. The apparatus of claim 4, wherein the predetermined vehicle operation comprises at least one of acceleration, braking, or steering.

6. The apparatus of claim 1, wherein the at least one instruction is configured, when executed by the processor, to further cause the apparatus to set, based on determining to change the autonomous driving mode, a mode switching time during which the changing of the autonomous driving mode is to be completed.

7. The apparatus of claim 6, wherein the mode switching time is based on user image data generated by photographing the user.

8. The apparatus of claim 1, wherein the first mode comprises an autonomous driving level 2, wherein the second mode comprises an autonomous driving level 3, and wherein the automatic mode change requirement comprises:
at least a section of a path to a final destination being suitable for the autonomous driving level 3,
a length of the section of the path being greater than or equal to a threshold distance,
the section of the path being an operation design domain (ODD), and
the vehicle not being in a minimum risk maneuver (MRM) situation.

9. The apparatus of claim 8, wherein the at least one instruction is configured, when executed by the processor, to further cause the apparatus to determine whether the section of the path is the ODD based on pre-stored map data.

10. The apparatus of claim 8, wherein the at least one instruction is configured, when executed by the processor, to further cause the apparatus to determine whether the section of the path is the ODD based on traffic condition data obtained by communicating with an external device.

11. The apparatus of claim 8, wherein the at least one instruction is configured, when executed by the processor, to further cause the apparatus to determine whether the section of the path is the ODD based on environment data generated by detecting a surrounding environment of the vehicle.

12. The apparatus of claim 8, wherein the at least one instruction is configured, when executed by the processor, to further cause the apparatus to determine whether the section of the path is the ODD based on at least one of: curvature data, weather data, or traffic data, for the path.

13. The apparatus of claim 1, wherein the first mode comprises an autonomous driving level 3 with a lane change function deactivated, wherein the second mode comprises an autonomous driving level 3 with the lane change function activated, and wherein the automatic mode change requirement comprises at least one of:
at least a section of a path to a final destination being suitable for the second mode,
a length of the section of the path being greater than or equal to a threshold distance,
the section of the path being an operation design domain (ODD), and
the vehicle not being in a minimum risk maneuver (MRM) situation.

14. The apparatus of claim 1, wherein the second mode comprises an autonomous driving level 3, and wherein the at least one instruction is configured, when executed by the processor, to further cause the apparatus to:
display, via a display device of the vehicle, at least one of:
a path to a final destination, or
a section of the path to be driven in the second mode.

15. A method performed by an apparatus of a vehicle, the method comprising:
changing, based on an input interface of the vehicle receiving no user request within a threshold time duration to change an autonomous driving mode of the vehicle, based on a manual mode change requirement being satisfied during the threshold time duration, and based on an automatic mode change requirement being satisfied, the autonomous driving mode from a first mode to a second mode; and
controlling the vehicle to perform an autonomous driving operation of the second mode.

16. The method of claim 15, further comprising:
changing, based on detecting a predetermined vehicle operation performed by a user, the autonomous driving mode to a standby mode.

17. An apparatus of a vehicle, the apparatus comprising:
a user interface;
a processor; and
a memory storing at least one instruction that is configured, when executed by the processor communicating with the memory, to cause the apparatus to:
control the vehicle to operate in a first autonomous driving mode;
based on determining that the user interface received, for at least a threshold time duration, no user request for a second autonomous driving mode, based on determining a cruise control speed of the vehicle being below a posted speed limit, and based on a road on which the vehicle is driving being suitable for the second autonomous driving mode, control the vehicle to operate in the second autonomous driving mode.

18. The apparatus of claim 17, wherein the at least one instruction is configured, when executed by the processor, to cause the apparatus to control the vehicle to operate in the second autonomous driving mode further based on at least one of:
the road being a highway, or
a longitudinal control mode of the vehicle being activated.

19. The apparatus of claim 17, wherein the first autonomous driving mode is an American Society of Automotive Engineers (SAE) autonomous driving level 1, and wherein the second autonomous driving mode is an SAE autonomous driving level 2.

20. The apparatus of claim 17, wherein the at least one instruction is configured, when executed by the processor, to cause the apparatus to control the vehicle to operate in the second autonomous driving mode by:
controlling the vehicle to operate in the second autonomous driving mode in a section of a path to a destination of the vehicle; and
indicating, via the user interface, that the second autonomous driving mode is activated for the section.
